(19) United States
(12) Patent Application Publication
(10) Pub. No.: US 2013/0326868 A1
(43) Pub. Date: Dec. 12, 2013

(54) GUIDE JIG

(71) Applicant: SUMITOMO WIRING SYSTEMS, LTD., Mie (JP)

(72) Inventors: Yoshihiro HISAKI, Yokkaichi-city (JP); Noriyasu SHIMA, Yokkaichi-city (JP); Masatoshi FURUICHI, Yokkaichi-city (JP)

(73) Assignee: SUMITOMO WIRING SYSTEMS, LTD., Mie (JP)

(21) Appl. No.: 13/744,994

(22) Filed: Jan. 18, 2013

(30) Foreign Application Priority Data
Jun. 6, 2012 (JP) 2012-129063

(51) Int. Cl. H01B 13/012

(52) U.S. Cl. CPC H01B 13/01227
USPC 29/755

(57) ABSTRACT

A guide jig having a novel structure capable of being fixated quickly and easily on a wiring diagram without damaging the wiring diagram and also capable of achieving a powerful fixative force when fixated on the wiring diagram. The guide jig includes a magnet body magnetically held to a diagram board main body, a wiring diagram being provided to the diagram board main body, and a support placed on the wiring diagram. A guide on which a wire harness runs is provided between the magnet body and the support. The support includes a friction member preventing the support from slipping with respect to the wiring diagram.

### CROSS-REFERENCE TO RELATED APPLICATIONS

The present application claims priority under 35 U.S.C. §119 of Japanese Application No. 2012-129063, filed on Jun. 6, 2012, the disclosure of which is expressly incorporated by reference herein in its entirety.

### BACKGROUND OF THE INVENTION

1. Field of the Invention

The present invention relates to a guide jig provided on a wiring diagram and guiding a wire harness when fabricating a wire harness.

2. Description of Related Art

Conventionally, as recited in Japanese Patent Laid-open Publication No. H02-065008 (Patent Literature 1), for example, a wire harness used in an automobile, airplane, or the like is formed in a desired shape by providing a guide jig on a wiring diagram and routing a plurality of electric wires (adjusted and clipped to an appropriate length) along the wiring diagram while guiding the electric wires with the guide jig.

Multiple wire harnesses are routed in an interior of the automobile or airplane and multiple kinds of wire harness are fabricated. Therefore, in a configuration where the guide jig is fixated through bolt tightening or the like to a diagram plate main body on which the wiring diagram is provided, each time a different wire harness is fabricated, time and effort is required to change a position of the guide jig. In particular, when a production volume is low, as in airplanes, the placement of the guide jig changes with increased frequency, which becomes a large factor in reducing fabrication efficiency. In addition, a bolt fixating the guide jig passes through the wiring diagram and may therefore damage the wiring diagram, which creates an obstacle to repeated use.

In order to address such circumstances, Japanese Utility Model Publication No. H04-102514 (Patent Literature 2) discloses using an electromagnet to magnetically hold a guide jig to a diagram board main body to which a wiring diagram is provided. Thereby, the guide jig can be rapidly mounted and dismounted, and damage to the wiring diagram can be avoided.

However, in the guide jig of Patent Literature 2, the electromagnet is provided directly below a guide portion on which the wire harness is run. As is well known, an adhering force of a magnet in a horizontal direction is weak compared to an adhering force in a perpendicular direction. Therefore, in the guide jig recited in Patent Literature 2, when the wire harness run on the guide portion is tugged, a tensile force in the horizontal direction acts on the electromagnet via the guide portion and the electromagnet is unlikely to achieve a sufficient resistive force and is likely to be displaced.

In Japanese Utility Model Publication No. H07-001538 (Patent Literature 3), the present applicants proposed a guide member in which a magnet is provided in a position away from a guide portion and in which the guide portion extends downward and forms a pointed end. Thereby, the pointed end projecting from the guide portion digs into the wiring diagram and acts as a levering pivot point, and thus a resistive force of the magnet can be improved.

However, the wiring diagram has a sheet shape and almost no thickness dimension, while the diagram board main body is a hard member of iron or the like. Therefore, the pointed end of the guide portion may not dig into the wiring diagram securely and a resistive force sufficient for the tensile force of the wire harness may not be achieved. In addition, in order to further improve the resistive force, the adhering force of the magnet must be strengthened or the magnet must be further separated from the guide portion, thus leading to increased size and weight for the magnet and to increased size for the guide jig. Meanwhile, when the pointed end of the guide portion digs firmly into the wiring diagram, the wiring diagram may be damaged by repeated use. There is thus further room for improvement.

Related Art 1: Japanese Patent Laid-open Publication No. 1102-065008

Related Art 2: Japanese Utility Model Publication No. 1404-102514

Related Art 3: Japanese Utility Model Publication No. H07-001538

### SUMMARY OF THE INVENTION

The present invention was made against the backdrop of the above-noted circumstances and provides a guide jig having a novel configuration capable of being fixated quickly and easily on a wiring diagram without damaging the wiring diagram and also capable of achieving a powerful fixative force when fixated on the wiring diagram.

A first aspect of the present invention is a guide jig provided on a wiring diagram for wiring a wire harness, the guide jig guiding the wire harness. The guide jig includes a guide on which the wire harness runs; a magnet body magnetically held so as to be capable of mounting to and dismounting from a diagram board main body configured with a magnetic material and including the wiring diagram; and a support placed on the wiring diagram. The guide is provided between the magnet body and the support. The support includes a friction member preventing the support from slipping with respect to the wiring diagram.

In the guide jig configured according to the present invention, the magnet body is provided to a first side and the support is provided to a second side with the guide therebetween. Thereby, when the wire harness is tugged and a tensile force acts on the guide in a horizontal direction (a direction parallel to the diagram board main body), the support acts as a pivot and thus most of the tensile force can be converted into a force acting in a direction perpendicular to the magnet body (a direction perpendicular to the diagram board main body). Accordingly, a characteristic of the magnet body capable of achieving a large magnetic force in the perpendicular direction can be effectively utilized and a resistive force sufficient for the tensile force can be achieved.

In particular, because the support includes the friction member, the support can be prevented from slipping and the tensile force in the horizontal direction acting on the guide can be effectively converted into a perpendicular-direction force on the magnet body. Accordingly, even when the positions of the support and the magnet body are comparatively close together, the horizontal-direction tensile force can be effectively converted into the perpendicular-direction force on the magnet body and an effective fixative force can be obtained without enlarging the guide jig. As a result, the guide jig can be made smaller and lighter, and can be applied to larger wire harnesses, as well.

Meanwhile, when the guide jig is detached from the diagram board main body, the guide jig can be readily detached by using the magnet body side as a pivot and lifting the guide jig from the pivot side, due to a levering effect of using the magnet body as a pivot. In addition, due to the configuration in which the guide jig is magnetically held to the diagram board main body by the magnet body, mounting and dismounting can be performed quickly, without requiring time and effort as in bolt tightening or the like. Moreover, the guide jig can be fixated to the diagram board main body using magnetic force and, because the support does not dig into the wiring diagram with the friction member, the guide jig can be fixated at a desired position on the wiring diagram without damaging the wiring diagram.

Moreover, “the guide is provided between the magnet body and the support” is not limited to providing only the magnet body on the first side and only the support on the second side with the guide therebetween. Rather, when focus is on a specific magnet body, the support may be provided to a side opposite the magnet body with the guide therebetween. For example, the magnet body may be provided in an annular shape around the guide and the support may be further provided in an annular shape outside the magnet body. Even in such a case, when focus is on a specific position of the annular magnet body, the support is provided on an opposite side with the guide therebetween.

A second aspect of the present invention is the invention described in the first aspect, in which a magnetic surface of the magnet body magnetically held to the diagram board main body is exposed and directly contacts the wiring diagram.

According to the present aspect, a distance between the diagram board main body (which is a magnetic material) and the magnetic surface of the magnet body is made as small as possible. Therefore, the magnetic force of the magnet body can be effectively obtained and can fixate more powerfully.

A third aspect of the present invention is the invention described in the first or the second aspect, in which the magnet body is a permanent magnet. According to the present aspect, compared to a case where the magnet body is configured with an electromagnet, the guide jig can be obtained with a simple structure and a comparatively low cost. In addition, electrical wiring is unnecessary and superior usability can be achieved.

A fourth aspect of the present invention is the invention described in any one of the first through third aspects, in which the friction member extends orthogonally with respect to a straight line connecting the magnet body with the guide. According to the present aspect, the friction member is formed to have width, and thus a pivot position of the support can be defined more broadly and an effective fixative force with respect to a tensile force can be obtained from a wider area.

A fifth aspect of the present invention is the invention described in any one of the first through fourth aspects including a stand supporting the guide, in which the magnet body and the support are provided to the stand.

According to the present aspect, the surface area of the magnet body and the support can be effectively preserved and compactness of the guide jig can be achieved. In addition, a center of gravity for the guide jig can be lowered and the guide jig can be fixated with greater stability. In addition, a shape of the stand is not limited to a rectangular shape. Any desired shape may be freely used, including polygonal shapes such as a triangular shape, a hexagonal shape, an octagonal shape, or the like, or circular shapes such as an ellipse.

A sixth aspect of the present invention is the invention described in the fifth aspect, in which the magnet body is provided only to a first side of the stand and the friction member is provided only to an opposite side of the stand with the guide between the magnet body and the friction member.

With the guide jig configured according to the present aspect, when a tensile force acts from the magnet body side toward the support side, the support acts as a pivot and the magnetic force of the magnet body is efficiently utilized. Thus, a powerful fixative force can be achieved. Meanwhile, when a force is applied in an opposite direction, the guide jig can be easily detached from the diagram board main body. Therefore, while achieving a powerful fixative force in a specified direction, the guide jig can be easily detached by applying a force in an opposite direction and the guide jig can be preferably employed in cases where a direction in which a tensile force from the wire harness acts can be specified ahead of time.

A seventh aspect of the present invention is the invention described in the fifth aspect, in which the stand has a rectangular shape and the magnet body is provided to four corners of the stand. In addition, the friction member is provided between the magnet bodies on outer peripheral portions of the stand.

In the present aspect, the guide is provided between the magnet bodies and the friction member when viewed from any direction. Therefore, an effective fixative force can be achieved regardless of the direction in which the tensile force acts and the guide jig can be effectively employed at a location where tensile forces are expected to act in various directions, such as at a branch point of the wire harness, for example.

An eighth aspect of the present invention is the invention described in any one of the fifth through seventh aspects, in which a calibration mark for positioning is provided on a surface of the stand opposite to the magnet bodies and the friction member.

According to the present aspect, even when the wiring diagram is hidden by the stand, by matching a position of the stand to a specified position on the wiring diagram using the calibration mark, the guide can be easily set in a desired position. Moreover, the specific nature of the calibration mark is not particularly limited and may, for example, be straight lines intersecting in a cruciate shape at the guide, or may be a suitable marking or the like. In addition, a method of forming the calibration mark is not particularly limited. The method is not limited to printing and may, for example, form the calibration mark by carving, or may form the calibration mark by affixing a sticker on which the calibration mark is printed to the stand.

In the present invention, the guide is provided between the magnet body and the support, and the friction member is provided to the support. Thus, when a tensile force acts on the guide, the support acts as a pivot and the tensile force can act as a perpendicular force on the magnet body. The magnetic force of the magnet body can thus be effectively achieved and a powerful fixative force can be obtained. Moreover, by providing the friction member to the support, the support can be prevented from slipping without damaging the wiring diagram and an efficient fixative force can be achieved.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a perspective view illustrating a guide jig as a first embodiment of the present invention, the guide jig being placed on a wiring diagram;

FIG. 2 is a bottom view of the guide jig illustrated in FIG. 1;

FIG. 3 is an overall schematic view of the wiring diagram on which the guide jig illustrated in FIG. 1 is placed;

FIG. 4 is a lateral view illustrating the guide jig illustrated in FIG. 1 placed on the wiring diagram;

FIG. 5 is a bottom view of a guide jig as a second embodiment of the present invention;

FIG. 6 is a bottom view of a guide jig as a third embodiment of the present invention;

FIG. 7 is a lateral view illustrating a guide jig as a fourth embodiment of the present invention, the guide jig being placed on a wiring diagram; and

FIG. 8 is a top view of the guide jig illustrated in FIG. 7.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

Hereafter, embodiments of the present invention are described with reference to the drawings.

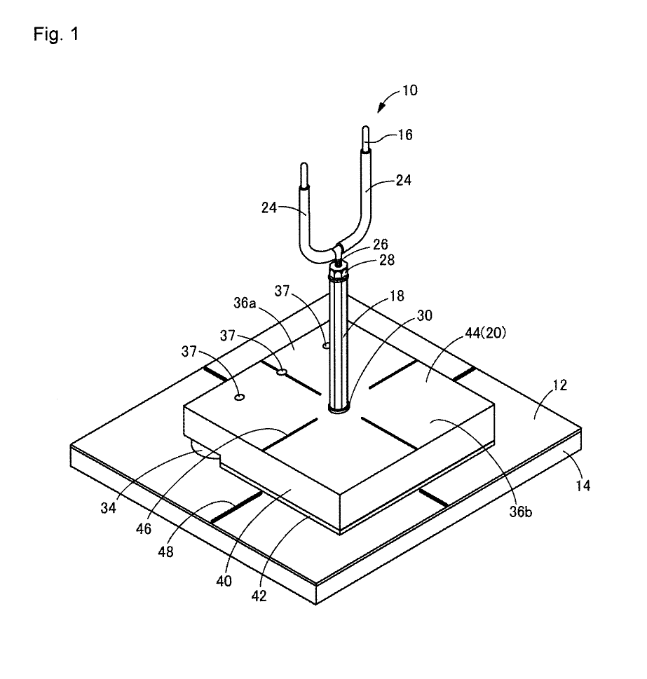

First, FIG. 1 illustrates a guide jig 10 as a first embodiment of the present invention, the guide jig 10 being placed on a diagram board main body 14, which includes a wiring diagram 12. The guide jig 10 is configured such that a guide 16 is supported by a stand 20 via a rod 18. Moreover, in the following description, an up-down direction is called a perpendicular vertical direction. The down direction is toward the wiring diagram 12.

The guide 16 has a “U” shape formed with metal or the like, and an insulating protective tube 24 made with rubber or a synthetic resin, for example, is fitted over an exterior thereof as needed. A downward-projecting male screw shaft 26 is integrally formed on the guide 16. The male screw shaft 26 is threaded into a female screw hole (not shown) provided to a top end of the rod 18 and is fixated with a lock nut 28.

The rod 18 has a pole shape made with metal or the like. A male screw (not shown) is formed on a bottom end of the rod 18. The male screw threads into a female screw stud 30 buried in a center of the stand 20. Thereby, the rod 18 projects upward on a central axis of the stand 20 and the guide 16 is supported by the stand 20 via the rod 18. In addition, by loosening the lock nut 28 and adjusting the threading amount of the male screw shaft 26 on the guide 16, a height position and an orientation of the guide 16 can be adjusted.

The stand 20 is an integrally molded article of synthetic resin or the like, for example. A specific shape of the stand 20 can employ various shapes; however, in the present embodiment, the stand 20 has a thick, square plate shape.

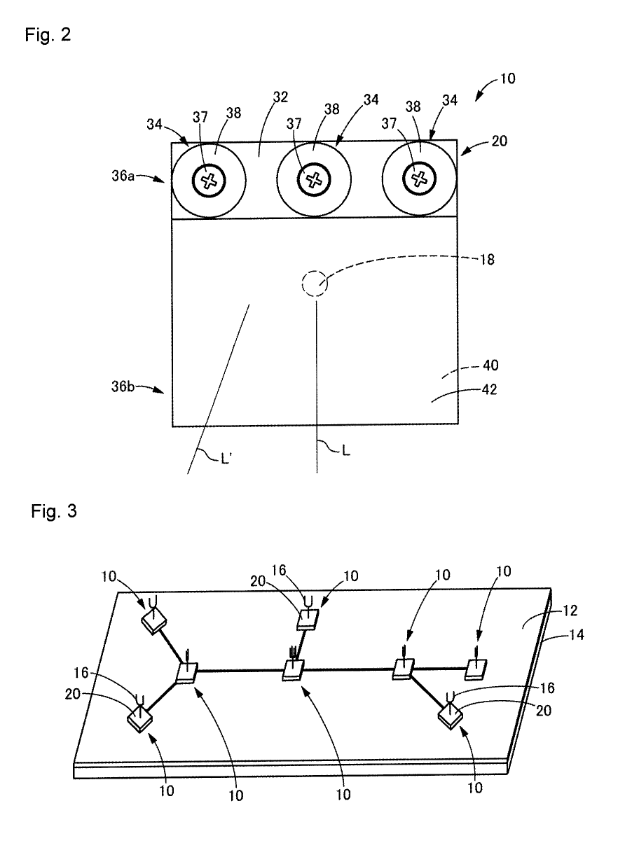

As shown in FIG. 2, a plurality (three in the present embodiment) of magnet bodies 34 are provided to a rear surface 32 of the stand 20. The magnet bodies 34 are permanent magnets and have a ring shape with a through-hole formed in a center thereof. However, the number and shape of the magnet bodies 34 can be configured as desired. Examples of magnets that can be employed as the magnet bodies 34 include various kinds of conventionally used magnets, such as an alnico magnet, a neodymium magnet, a ferrite magnet, a samarium-cobalt magnet, and the like. In the present embodiment, a permanent magnet made with neodymium is used.

The magnet bodies 34 are fixated in a line on a first edge 36a of the stand 20. A method for fixating the magnet bodies 34 is not limited. For example, the magnet bodies 34 may be adhered using an adhesive, affixed using double-sided tape or the like, or fixated by insert molding on the stand 20. In the present embodiment, magnets made of neodymium are used as the magnet bodies 34. Although a powerful magnetic force is thus obtained, strength of the magnet bodies is comparatively weak. Therefore, the magnet bodies 34 are screwed to the stand 20 with screws 37. Accordingly, the magnet bodies 34 may be easily swapped out when broken. Moreover, a magnetic surface 38 of the magnet bodies 34 is not covered by another member such as a friction member 42 (described hereafter) and is instead directly exposed to an exterior.

In addition, a support 40 is formed on an edge 36b of the stand 20 opposite to the edge 36a where the magnet bodies 34 are provided. The support 40 is formed along an entire length of the edge 36b and extends along an entire length in a width direction (a left-right direction in FIG. 2) of the stand 20, orthogonal to a straight line L connecting the guide 16 with the magnet bodies 34. Accordingly, the guide 16 is provided between the magnet bodies 34 and the support 40. In particular, in the present embodiment, the magnet bodies 34 are provided to only a first side (a top side in FIG. 2) and the support 40 is provided to only a second side (a bottom side in FIG. 2) with the guide 16 therebetween.

The support 40 includes the friction member 42. Anything having a high friction coefficient may be favorably employed as the friction member 42, such as an elastomer of rubber, silicone rubber, or the like. In the present embodiment, a sheet made with ethylene-propylene-diene rubber (EPDM) foam is used. The friction member 42 is adhered to the support 40 on the rear surface 32 of the stand 20. In particular, in the present embodiment, the friction member 42 is fixated to substantially the entire rear surface 32 of the stand 20, except for a region where the magnet bodies 34 are provided. Moreover, a method of fixating the friction member 42 is not particularly limited. The friction member 42 may be adhered to the support 40 or may be affixed using double-sided tape or the like. In addition, a front surface of the friction member 42 is positioned on the same horizontal plane as the magnetic surfaces 38 of the magnet bodies 34 so as to enable stable placement on the wiring diagram 12.

Meanwhile, as shown in FIG. 1, a calibration mark 46 is formed on a front surface 44 of the stand 20. The nature of the calibration mark 46 is appropriately defined as necessary. In the present embodiment, the calibration mark 46 has a cruciate shape intersecting at a center of the guide 16 and marks a center of the guide 16 at the point of intersection in the cross shape. Any desired method for forming the calibration mark 46 may be used and the method is not limited to printing. The calibration mark 46 may be formed by being carved into the stand 20 or by affixing stickers pre-printed with the calibration mark 46 to the stand 20. Moreover, when the calibration mark 46 is formed by affixing stickers, stickers which are transparent and which have the calibration mark 46 printed on an affixed surface are preferably used. Thereby, the calibration mark 46 is not directly exposed to the exterior and can be protected from contact with other members, bonding of a solvent, and the like. The position of the calibration mark 46 is matched to a positioning mark 48 provided to the wiring diagram 12. Thereby, the guide 16 can be readily placed in a desired position on the wiring diagram 12.

As shown in FIG. 3, the guide jigs 10 having such a configuration are placed on the wiring diagram 12, which is provided to the diagram board main body 14. The diagram board main body 14 is formed with a magnetic material such as an iron plate, for example, and is placed atop a work stand. The wiring diagram 12 is a sheet formed with film, paper, or the like on which a full scale diagram of a desired wiring has been scribed. The wiring diagram 12 is affixed to the diagram board main body 14 using adhesion, tape, or the like.

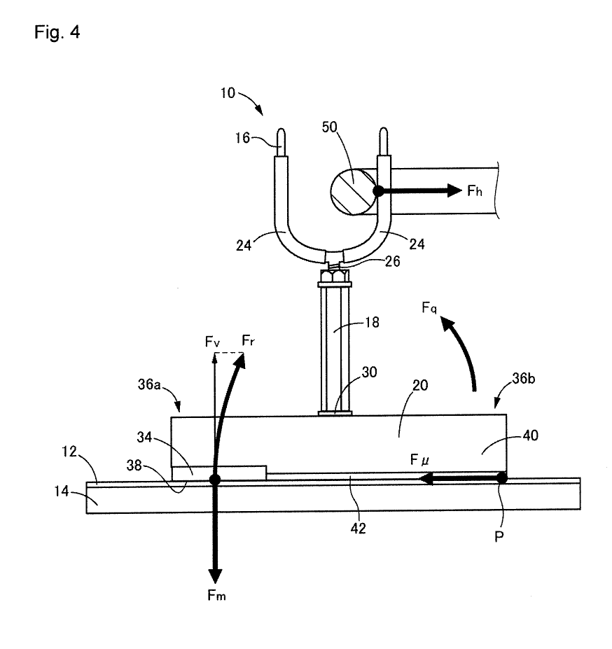

In addition, as shown in FIG. 4, the magnet bodies 34 are positioned on a side opposite to a direction in which a tensile force Fh of a wire harness 50 is expected to act. The magnet bodies 34 are magnetically held to the diagram board main body 14 with the wiring diagram 12 therebetween. Thereby, the support 40 is placed on the wiring diagram 12 with the friction member 42 interposed therebetween. In this way, the guide jig 10 is placed on the wiring diagram 12 and the wire harness 50 is guided on the guide 16, thus wiring the wire harness 50 along the wiring diagram 12.

By running the wire harness 50 on the guide 16, the guide jig 10 can guide the wire harness 50. In addition, in a case where the wire harness 50 is tugged or the like and the tensile force Fh acts on the guide 16 in a horizontal direction parallel to the wiring diagram 12 (from left to right in FIG. 4), the friction member 42 generates a high friction force Fp between the wiring diagram 12 and the friction member 42. The support 40 is thus prevented from slipping with respect to the wiring diagram 12. Thereby, a tensile force Fr acts on the magnet bodies 34 in a direction lifting the magnet bodies 34 away from the wiring diagram 12 in a rotation direction that rotates around a pivot point P (where the support 40 serves as the pivot point P). Most of tensile force Fr in the rotation direction is a tensile force Fv in a perpendicular direction perpendicular to the wiring diagram 12 (upward from below in FIG. 4). In addition, a magnetic force Fm of the magnet bodies 34 is capable of great force in the perpendicular direction, and can thus achieve an effective resistive force to the tensile force Fv in the perpendicular direction. In particular, in the present embodiment, the magnetic surfaces 38 of the magnet bodies 34 are exposed to the exterior and directly contact the wiring diagram 12. Therefore, a distance between the magnetic surfaces 38 and the diagram board main body 14 can be reduced as much as possible and a large magnetic force can be obtained. As a result, the guide jig 10 can be prevented from shifting position and from falling off. In other words, due to the support 40 and the friction member 42 provided thereto, the present embodiment is configured with an action direction converter converting the horizontal-direction tensile force Fh acting on the guide 16 into the perpendicular-direction tensile force Fv on the magnet bodies 34. Thus, the perpendicular-direction magnetic force Fm of the magnet bodies 34 can be effectively utilized and a great resistive force can be achieved.

In addition, the stand 20 is provided supporting the guide 16. The magnet bodies 34 and the friction member 42 are provided to the stand 20. Therefore, the guide jig 10 can be formed compactly while effectively preserving an area for the magnet bodies 34 and the friction member 42. In particular, the friction member 42 is provided to substantially the entire area containing the support 40 where the magnet bodies 34 are not formed. Therefore, the support 40 can be effectively prevented from slipping. The friction member 42 is formed along the entire length in the width direction (left-right direction in FIG. 2) of the stand 20. Therefore, as shown by a straight line L′ in FIG. 2, even when the direction of the tensile force Fh acts at a measurable inclination from the straight line L connecting the magnet bodies 34 and the guide 16, a pivot point is configured on the straight line L′ and an effective resistive force can be achieved.

Moreover, the magnet bodies 34 are provided to only the first edge 36a of the stand 20 and the friction member 42 is provided to only the second edge 36b of the stand 20. Thereby, when the tensile force Fh acts in a direction away from the magnet bodies 34 and toward the friction member 42 (from left to right in FIG. 4), the magnetic force of the magnet bodies 34 can be effectively utilized and a powerful fixative force can be achieved. Meanwhile, in contrast, when a force Fq is applied lifting the friction member 42 side with the magnet bodies 34 as a pivot, the magnetic hold of the magnet bodies 34 is readily released due to a levering effect and the guide jig 10 can be detached from the wiring diagram 12. In this way, according to the present embodiment, a powerful fixative force can be achieved with respect to a tensile force in a specific direction (from left to right in FIG. 4). Meanwhile, with the application of a force in the opposite direction, the guide jig 10 can be readily detached and can be favorably used in a position where the tensile direction of the wire harness 50 can be predicted.

The magnet bodies 34 are permanent magnets and can therefore be manufactured with a simple structure and at a comparatively low cost in comparison to electromagnets. Moreover, electrical wiring is unnecessary, and thus excellent usability can be achieved.

In addition, because the magnet bodies 34 are fixated to the diagram board main body 14 with the magnetic attractive force, there is no need to create holes in the wiring diagram 12 as when bolts fixation is used. In addition, the support 40 is in surface contact with the wiring diagram 12, with the friction member 42 interposed therebetween. Therefore, the support 40 can also be prevented from digging into the wiring diagram 12. As a result, the guide jig 10 can be placed without damaging the wiring diagram 12.

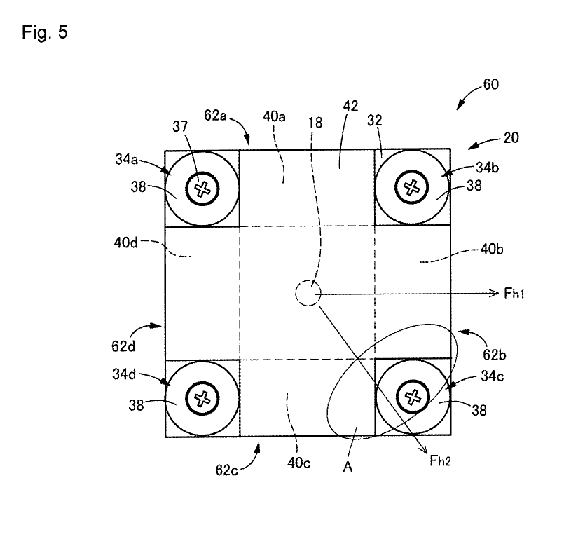

Next, FIG. 5 illustrates a guide jig 60 as a second embodiment of the present invention. In the description that follows, components and locations having configurations similar to those of the first embodiment are given the same reference numerals in the drawings as those of the first embodiment. Descriptions thereof are accordingly omitted.

In the guide jig 60 of the present embodiment, the mode of placing the magnet bodies 34 on the stand 20 and the position at which the support 40 is formed on the stand 20 differ as compared to the first embodiment. Specifically, in the present embodiment, magnet bodies 34a to 34d are placed in four corners of the rear surface 32 of the square stand 20. In addition, a support 40a to 40d is respectively formed in each outer peripheral portion 62a to 62d of the stand 20, between each of the magnet bodies 34a to 34d. In addition, the friction member 42 of the present embodiment has a square shape with four corners cut away. The friction member 42 is placed on substantially the entire rear surface 32, excluding the magnet bodies 34a to 34d, and is placed so as to straddle all of the supports 40a to 40d. However, the friction member 42 may, for example, also be provided individually to each of the supports 40a to 40d by having a long rectangular shape and being provided separately to each of the outer peripheral portions 62a to 62d.

According to the present embodiment, the magnet bodies 34a and 34d are positioned on a side opposite the support 40b with the guide 16 therebetween. When a tensile force acts from an outer peripheral portion 62d side toward an outer peripheral portion 62b side (as in a direction of an arrow Fh₁ in FIG. 5, for example), the support 40b acts as a support and the magnetic force of the magnet bodies 34a and 34d functions effectively. Thus, a powerful fixative force can be achieved. In a case where the tensile force acts from a corner where the magnet body 34a is provided toward a corner where the magnet body 34c is provided (as in a direction of an arrow Fh₂ in the same figure), a region A acts as a support. The region A is on the magnet body 34c side of the supports 40b and 40c. The magnetic force of the magnet body 34a (positioned on a side opposite the region A) functions effectively and thus a powerful fixative force can be achieved. Thereby, regardless of the direction in which the tensile force acts, one or two of the magnet bodies 34 functions, and thus an effective fixative force can be achieved. Accordingly, the present embodiment can be favorably employed, for example, at a branch point of the wire harness 50, where tensile forces acting from various directions are anticipated.

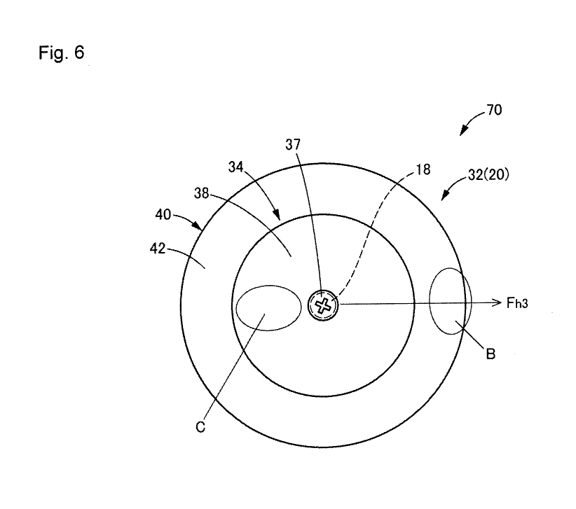

Next, FIG. 6 illustrates a guide jig 70 as a third embodiment of the present invention. The stand 20 of the guide jig 70 has a circular shape. In addition, a magnet body 34 having a circular shape is positioned on the same center axis as the stand 20 and is fixated to the rear surface 32 of the stand 20 with the screw 37 or the like. Moreover, the support 40 (having an annular shape) is formed on an outer peripheral portion of the rear surface 32, encircling an outer side of the magnet body 34 around the entire periphery thereof In addition, the friction member 42 (having an annular shape corresponding to the shape of the support 40) is provided on the outer peripheral portion of the rear surface 32.

In the present embodiment, when a tensile force acts on the guide 16, as shown by an arrow Fh₃ in FIG. 6, a region B on the annular support 40 is positioned in an action direction of the tensile force acting on the guide 16. The region B acts as a pivot and the magnetic force of a region C on the magnet body 34 functions effectively, the region C being on a side opposite the region B with the guide 16 therebetween. A powerful fixative force can thus be achieved. In addition, the magnet body 34 and the support 40 have similar shapes around the entire periphery thereof. Therefore, a similar resistive force can be obtained with respect to a tensile force in any direction, and a stable fixative force can be obtained around the entire periphery.

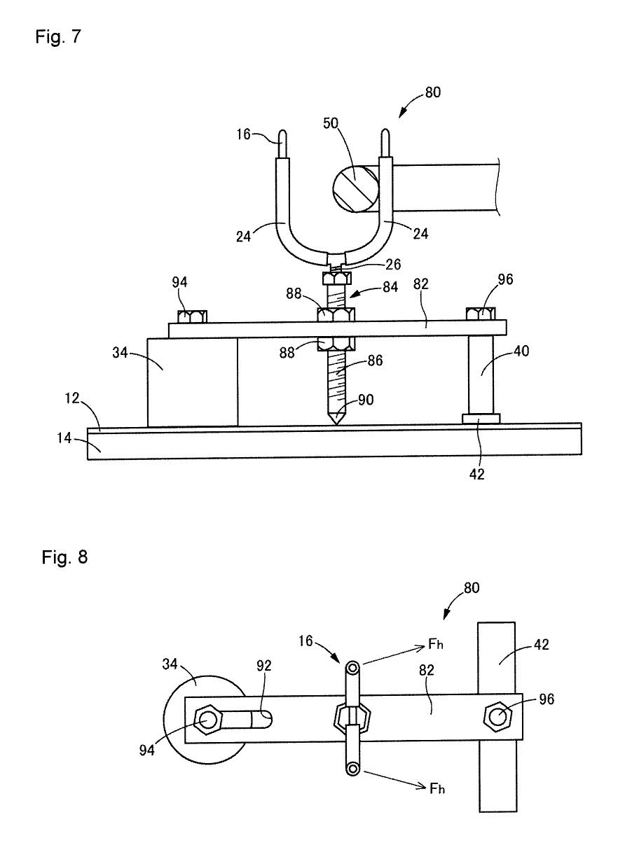

Next, FIGS. 7 and 8 illustrate a guide jig 80 as a fourth embodiment of the present invention. The guide jig 80 includes the guide 16 at a central portion in a length direction (left-right direction in FIG. 7) of an offset stay 82 having a long plate shape. In addition, the guide jig 80 is configured to include the magnet body 34 on a first end of the offset stay 82 while the support 40 is provided to a second end of the offset stay 82, with the guide 16 therebetween.

The guide 16 is supported by a rod 84. A male threading 86 is formed on an outer peripheral surface of the rod 84. The rod 84 is inserted through an insertion through-hole (not shown) running through the center in the length direction of the offset stay 82. The rod 84 is then tightened and fixated from both vertical (up-down in FIG. 7) surfaces with a pair of nuts 88 and 88. Similar to the first embodiment, a female screw hole (not shown) is formed on a top end of the rod 84 and the guide 16 is fixated to the offset stay 82 via the rod 84 by threading and fixating the male screw shaft 26 of the guide 16 with the lock nut 28.

The rod 84 passes through the offset stay 82 and projects downward. A downward-projecting foremost end of the rod 84 has a tapered shape in which a diameter gradually reduces further down the rod 84. The foremost edge of the rod 84 is a positioning portion 90. Thus, the positioning portion 90 is positioned on the central axis of the guide 16. Moreover, the foremost edge of the positioning portion 90 preferably has a wavy surface shape so as not to damage the wiring diagram 12.

The magnet body 34 is a permanent magnet having a columnar shape. A bolt insertion through-hole 92 is provided through a first end of the offset stay 82, the bolt insertion through-hole 92 having a slit shape extending in a length direction of the offset stay 82. The magnet body 34 is fixated to the first end of the offset stay 82 using a bolt 94 inserted through the bolt insertion through-hole 92. Moreover, by loosening the bolt 94, the position of the magnet body 34 can be adjusted in the length direction of the bolt insertion through-hole 92.

Meanwhile, the support 40 has a pole shape formed with metal or the like. The support 40 is fixated to an end of the offset stay 82 opposite the magnet body 34 by a bolt 96 inserted through a bolt insertion hole (not shown) provided through the end of the offset stay 82. Moreover, the support 40 may be integrally formed with the offset stay 82. The support 40 projects downward from the offset stay 82 and includes the friction member 42 on the downward-projecting end of the support 40. The friction member 42 preferably extends along a predetermined dimension in a direction (vertical direction in FIG. 8) orthogonal to the length direction of the offset stay 82 (left-right direction in FIG. 8), which connects the magnet body 34 to the guide 16.

In the guide jig 80 configured according to the present embodiment, by having the support 40 as a pivot, the magnetic force of the magnet body 34 can be effectively employed and a powerful fixative force can be obtained. In addition, with the present embodiment, the positioning portion 90 projects from the offset stay 82, which has a long, thin plate shape, and thus the central axis of the guide 16 can be readily recognized visually. The guide 16 can thus be provided to a desired position on the wiring diagram 12 with greater ease. As made clear by the present embodiment, a stand similar to that in the first embodiment is not strictly necessary.

The friction member 42 has a shape extending along a predetermined dimension in a direction orthogonal to a straight line connecting the guide 16 to the magnet body 34 (vertical direction in FIG. 8). In this way, by allotting a certain width to the friction member 42, the resistive force with respect to the tensile force Fh acting in multiple directions (indicated by arrows in FIG. 8) can be improved.

Above, embodiments of the present invention were described in detail. However, the present invention is not limited by these specific descriptions. For example, the magnet body may employ not only a permanent magnet, but may also employ an electromagnet. The magnet body may also employ a configuration capable of operations to magnetically hold and release through operation of a lever to control magnet shielding with a magnetic shield member of a strongly magnetic material or the like. Moreover, the shape of the magnet body is not limited. Various shapes may be employed, such as a thick rectangular or circular block shape, a thin plate shape, or the like.

In addition, the friction member provided to the support may be provided at least to the support, and is not limited to being provided only to the support. For example, the friction member may be provided to both the support and the magnet body so as to cover the magnetic surface of the magnet body with the friction member. Thereby, a shock to the magnet body accompanying a magnetic hold on the diagram board main body can be alleviated by the friction member.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A guide jig configured to be provided on a wiring diagram for wiring a wire harness, and to guide the wire harness, the guide jig comprising:
a guide on which the wire harness runs;
a magnet body configured to be magnetically held so as to be capable of mounting to and dismounting from a diagram board main body configured with a magnetic material, the wiring diagram being provided to the diagram board main body; and
a support placed on the wiring diagram, wherein
the guide is provided between the magnet body and the support, and
the support includes a friction member preventing the support from slipping with respect to the wiring diagram.

2. The guide jig according to claim 1, wherein a magnetic surface of the magnet body magnetically held to the diagram board main body directly contacts the wiring diagram.

3. The guide jig according to claim 1, wherein the magnet body is a permanent magnet.

4. The guide jig according to claim 1, wherein the friction member extends orthogonally with respect to a straight line connecting the magnet body with the guide.

5. The guide jig according to claim 1, further comprising a stand supporting the guide, wherein the magnet body and the support are provided to the stand.

6. The guide jig according to claim 5, wherein the magnet body is provided only to a first side of the stand and the friction member is provided only to an opposite side of the stand with the guide between the magnet body and the friction member.

7. The guide jig according to claim 5, wherein
the stand has a rectangular shape and magnet bodies are provided to four corners of the stand, and
the friction member is provided between the magnet bodies on outer peripheral portions of the stand.

8. The guide jig according to claim 5, wherein a calibration mark for positioning is provided on a surface of the stand opposite to the magnet body and the friction member.
